(19) United States
(12) Patent Application Publication
(10) Pub. No.: US 2026/0042498 A1
(43) Pub. Date: Feb. 12, 2026

(54) TRACK FRAME-MOUNTED DRIVE UNIT FOR TRACKED MACHINES

(71) Applicant: Lumina Technology Inc., Lewes, DE (US)

(72) Inventors: Glenn Alun Andrew Melford-Colegate, Wellington (GB); Ahmed Shubber, Austin, TX (US)

(21) Appl. No.: 18/796,331

(22) Filed: Aug. 7, 2024

(51) Int. Cl. B62D 55/06; B62D 55/10; B62D 55/125; B62D 55/24

(52) U.S. Cl. CPC B62D 55/06; B62D 55/10; B62D 55/125; B62D 55/24

(57) ABSTRACT

Embodiments are described providing efficient ways to power each track of a tracked machine by an electrical motor mounted to the track frame. In particular, a separate drive unit with an electrical motor can be mounted to each track frame of the tracked machine to turn a sprocket driving the corresponding track, providing various benefits, including greater freedom of movement of the track frame with respect to the main frame, eliminating the need for a differential steering mechanism connecting a single central power source to the tracks, easier maintenance, and so on.

### TECHNICAL FIELD

The present disclosure generally relates to tracked machines, and more particularly to a track frame-mounted electrical motor drive unit for a tracked machine.

### BACKGROUND OF THE INVENTION

Traditionally, tracked machines such as bulldozers, tractors, etc. utilized a central power source, commonly a diesel engine, mounted on the main frame to power the machine. Typically, the power source turned sprockets rotatably mounted on either side of the main frame via shafts that extended out of the frame, and each sprocket in turn drove a continuous track to propel the machine. Each continuous track was normally supported by freely rotating idler wheels and rollers mounted to a track frame that held the continuous track as it rotated. To allow the machine to better navigate uneven terrain, each track frame could move to a certain degree with respect to the main frame, generally by pivoting, so that the tracks could better accommodate the ground.

However, a limitation of the traditional tracked machine design having a sprocket mounted to the main frame is that, because the position of the sprocket relative to the main frame is fixed and the sprocket needs to maintain consistent contact with the track, the movement of the track frame with respect to the main frame is constrained, thereby limiting the track frame's permissible range of movement. As a result, the size of obstacles that the machine can traverse was limited and the operator comfort as the machine navigated obstacles was likewise negatively impacted.

Further, tracked machines traditionally implemented a differential steering mechanism connecting the central power source to the tracks, which was operable to change relative speeds of the tracks in order to steer the machine. For example, the differential steering mechanism could increase the speed of one track and decrease the speed of the other to turn the tracked machine. However, such differential steering mechanisms are complex and expensive, having a substantial impact on machine price, reliability, and costs of maintenance.

What is needed is a design that solves one or more of the problems associated with existing tracked machines.

### BRIEF DESCRIPTION OF DRAWINGS

FIG. 1 illustrates an example of a tracked machine, in accordance with various embodiments.

FIG. 2 illustrates an example drive unit, in accordance with various embodiments.

FIG. 3 illustrates a cross-sectional view of a drive unit mounted to a track frame, in accordance with various embodiments.

### DETAILED DESCRIPTION OF THE INVENTION

Embodiments described in the present disclosure overcome at least some of the above-mentioned shortcomings and deficiencies by providing efficient ways to power each track of a tracked machine by an electrical motor mounted to the track frame. In particular, a separate drive unit with an electrical motor can be mounted to each track frame of the tracked machine to turn a sprocket driving the corresponding track, providing various benefits, including greater freedom of movement of the track frame with respect to the main frame, eliminating the need for a differential steering mechanism connecting a single central power source to the tracks, easier maintenance, and so on.

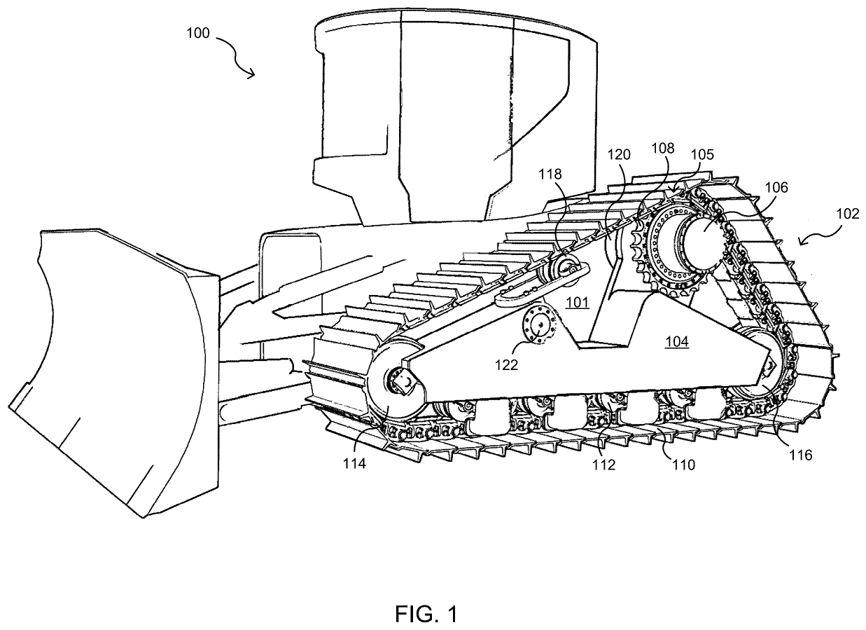

FIG. 1 illustrates an example of a tracked machine, in accordance with various embodiments. As illustrated in the example of FIG. 1, the tracked machine 100 includes a main frame 101 and a track assembly 102 supported on the side of the main frame 110. Although not illustrated in the example of FIG. 1, it is understood that a complementary track assembly with analogous components is supported on the other side of the main frame 101 and all applicable descriptions relating to the illustrated track assembly 102 can likewise apply to the complementary track assembly.

Each track assembly 102 includes a track frame 104 with a drive unit 105 mounted to the track frame 104. As illustrated, the track frame 104 extends towards the drive unit 105 (upwards in this case) and provides a mounting surface to which the drive unit 105 can be connected to mount it to the track frame 104. The drive unit 105 comprises an electrical motor module 120 that drives a final drive assembly 106 holding a sprocket 108. The sprocket 108 is rotatably mounted on the track frame 104 via the final drive assembly 106 to engage and support a continuous track 110. As will be appreciated by those skilled in the art, the continuous track 110 can be any track-type ground-engaging device that can be moved by rotation of the sprocket 108 on the final drive assembly 106 to propel the tracked machine 100.

As illustrated, the continuous track 110 is supported on the track frame 104 by a plurality of rollers 112 rotatably mounted to the track frame 104 that are configured to allow movement of the continuous track 110 about the track frame 104. As will be appreciated by those skilled in the art, the rollers 112 may be fastened directly to the track frame 104 or connected thereto in a moveable fashion to better accommodate uneven ground.

The track frame further supports a front idler 114 and a rear idler 116, both of which are rotatably mounted to the track frame. The front and rear idlers 114, 116 can be configured to keep the continuous track 110 on its path as well as to regulate tension of the continuous track 110. A top roller 118 can also be mounted on the track frame (either directly or via an intermediate member) to maintain the shape (prevent sagging) of the continuous track 110.

As will be appreciated by those skilled in the art, the track assembly 102 may contain various other components and mechanisms such as recoil mechanisms, track adjusters, and so on that are not described herein so as not to obscure the salient parts of the invention. Furthermore, while the example of FIG. 1 illustrates a tracked machine in what is known as a high-drive configuration, the embodiments disclosed herein are equally applicable to other variations of tracked machines whether utilizing the high-drive configuration, a flat track configuration, or otherwise.

The drive unit 105 comprises an electrical motor module 120 for driving the final drive assembly 106 and sprocket 108. The electrical motor module 120 contains one or more electrical motors. In embodiments utilizing two or more motors in the electrical motor module 120, the motors can be stacked in axial alignment and turn the same rotor shaft, or their rotor shafts can be mechanically coupled so they turn together. The output shaft of the electrical motor module 120 is in rotational connection with the final drive assembly 106 for driving the sprocket 108. As will be appreciated by those skilled in the art, the final drive assembly 106 can contain any of various mechanisms for converting the rotational speed and torque produced by the electrical motor module 120 as desired. The mechanism may include various gear reduction assemblies, such as planetary gearsets.

The track assembly 102 is movably supported on the main frame 101 so that it can oscillate to accommodate uneven terrain traversed by the track machine 100. For example, as illustrated, the track assembly 102 can be pivotally supported on the main frame 101 by a pivot shaft 122 extending out from the side of the main frame 101. It is understood that the complementary track assembly on the other side of the track machine 100 can likewise pivot on a shaft extending out from the other side of the main frame 101.

An equalizer bar (not illustrated) can connect the two track assemblies 102 together. The equalizer bar 102 can extend between the track assemblies 102 on the opposite sides of the main frame 101 and may be pinned in the middle to the underneath of the main frame 101. When one track assembly 102 pivots up, the equalizer bar can force the track assembly 102 on the other side to pivot down, and vice versa. This aids in distributing the weight of the track machine 100 as the machine moves over uneven terrain and maintaining sufficient contact of the tracks 110 with the ground. Equalizer bars and their functioning is well understood in the field and is not discussed in great detail herein for the sake of being concise.

As mentioned previously, by supporting the drive unit 105 on the track frame 104, significantly greater freedom of movement of the track frame 104 in relation to the main frame 101 can be achieved than with traditional approaches. Unlike traditional designs where the position of the sprocket and final drive was fixed in relation to the machine frame, in this design the drive unit 105, including the sprocket 108, final drive 106, and motor module 108, is free to move with the track frame 104 in relation to the main frame, allowing for much greater range of motion of the track frame 104 and track assembly 102.

Additionally, this arrangement allows for greater flexibility in the placement of the pivot shaft 122. For example, in traditional arrangements, the pivot shaft generally had to be located near the sprocket to bring the axis of rotation of the track frame closer to the sprocket because the final drive and the pivot shaft were both fixed to the main frame and bringing the pivot point closer to the sprocket decreases the deviation of the track from the sprocket as the track oscillates. In embodiments described herein, the position of the pivot shaft is no longer constrained with relation to the position of the final drive and sprocket and, therefore, the pivot shaft can be moved away from the sprocket and final drive, which may be more desirable. As illustrated in the example of FIG. 1, the pivot shaft 122 is positioned a significant distance away from the final drive 106 and sprocket 108, whereas in traditional high drive designs the pivot shaft was positioned in closer proximity to the final drive. As illustrated, the pivot shaft 122 is positioned closer to the font idler 114 than the rear idler 116, while the final drive 106 and sprocket 108 are positioned closer to the rear idler 116 than to the front idler 114. This kind of arrangement may not be practicable with past designs where sprockets and final drives are mounted on the main frame.

In various embodiments, the tracked machine 100 can be steered (i.e., turned) by operating the respective motor module 120 of each drive assembly 102 at different speeds, which in turn will cause the respective continuous tracks 110 to move at different speeds. When one continuous track 110 moves faster than the other continuous track, the machine 100 will turn in the direction of the slower moving continuous track. This eliminates the need for traditional differential steering mechanisms used in past tracked machines, which were complex and expensive.

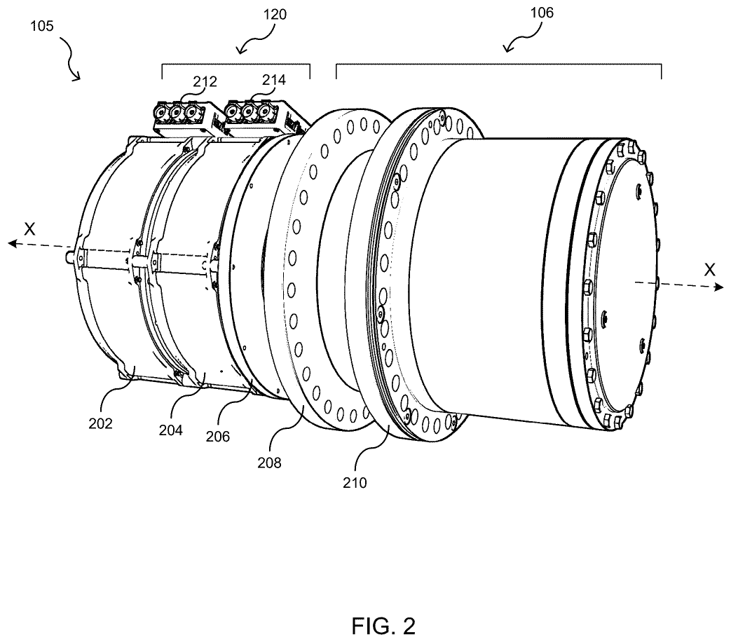

FIG. 2 illustrates an example drive unit, in accordance with various embodiments. As illustrated, the drive unit 105 includes an electrical motor module 120 comprising a first electrical motor 202 and a second electrical motor 204. Each motor 202, 204 has corresponding electrical connections 212, 214, which can include connections for three high-voltage phase cables as illustrated, as well as other low voltage connections that can be for control (not illustrated).

The first electrical motor 202 and the second electrical motor 204 are in a stacked configuration where the housings of the motors are connected to each other (e.g., with removable fasteners such as bolts allowing for servicing). The rotor shafts of the motors 202, 204 can be mechanically coupled so they turn in unison. In other embodiments, the motors can turn the same, shared rotor shaft. The motor module 120 is connected to a motor mounting flange 206 to mount the motor module 120 to the final drive assembly 106. The motor mounting flange 206 can extend internally or otherwise connect to the final drive mounting flange 208 so the motor module 120 effectively becomes mounted to the track frame 104 when the drive assembly 106 is mounted to the track frame 104. The final drive mounting flange 208 further supports a spindle in the final drive assembly 106 that rotatably supports rotating components of the final assembly 106 including a sprocket support flange 210.

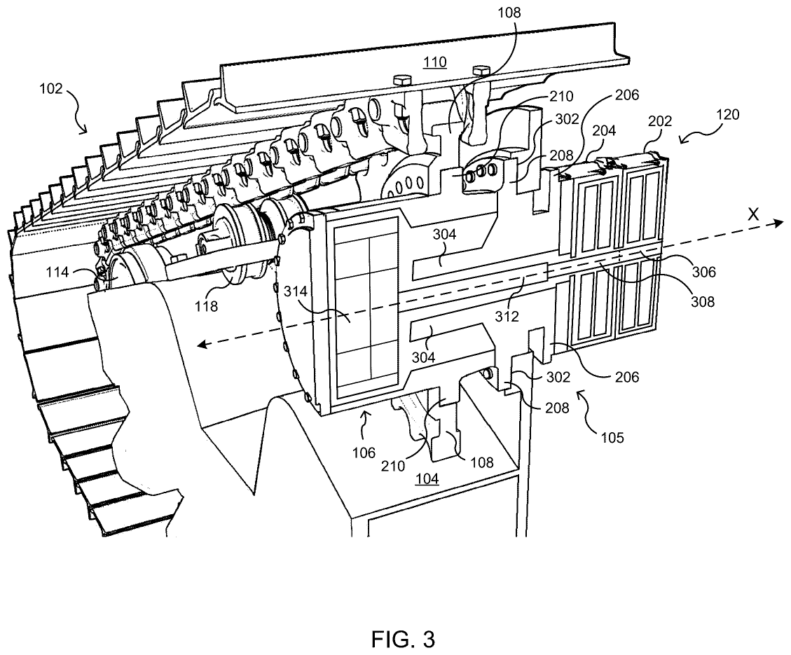

The final drive mounting flange 208 can be fastened to a complementary mounting surface on the track frame 104 (illustrated in FIG. 3) to mount the final drive 106 (and, in turn, the drive unit 105) to the track frame 104. Fasteners such as bolts can be used to mount the final drive 106 through the illustrated holes in the final drive mounting flange 208.

A rotor shaft (not illustrated) turned by the motors 202, 204 in the motor module 120 can extend from the motor module 120 and make a rotational connection with the final drive assembly 106 for driving the sprocket 108 (illustrated in FIG. 1). The sprocket 108 can be mounted to the sprocket mounting flange 210 on the final drive assembly 106 using fasteners such as bolts through the illustrated holes in the sprocket mounting flange 210. As will be appreciated by those skilled in the art, the rotor shaft can engage various types of reduction gear sets in the final drive assembly 106 for achieving desired reduction, such as planetary gears. For achieving greater gearing reduction, stacked planetary gears or double reduction planetary gears may be used in the final drive 106, which may be desirable with high speed electrical motors.

With the drive unit 105 mounted to the track frame 104, the motor module 120 can be operated to turn the rotatable portion of the final drive assembly 106 including the sprocket mounting flange 210 and a sprocket mounted thereto to move the tracks 110 and propel the machine. In this arrangement, the rotational axis “X” of the motors 202, 204 in the motor module 120 coincides with the rotational axis of the final drive 106 and, accordingly, the sprocket 108, which provides various advantages.

As illustrated, the motors 202, 204 can be “pancake” style or “flat” motors that are shorter in the dimension along the rotational axis than other types of motors with similar power output. Such pancake motors are also generally shorter in the dimension along the rotation axis than they are in diameter, earning them the “pancake” or “flat” designation. In various embodiments, the motors 202, 204 may be axial flux type motors. These types of motors may be preferable in the implementation because of their performance characteristics and because the “flat” form factor can result in less cantilevered mass and a more compact design. For example, in the configuration illustrated in FIG. 1, the motors extend inwards towards the body of the tracked machine 100. The motors take up space towards the interior of the machine 100 and also require space to move as the track assemblies 102 oscillate. In this case, a flat motor design can be a significant benefit as it would not extend inwards as far and would consume less space in the area on the inside of the track assembly 102 than other types of motors.

In various embodiments, the motor module 120 can comprise a single motor, which may be an axial flux motor or any other type of electrical motor. These embodiments may be preferable for reducing the added complexity of using multiple motors. In yet another embodiment, the motor module 120 can comprise more than two motors (e.g., 3, 4, etc.) that are stacked together. It should also be noted that other components may be incorporated in the drive unit that are not described here for the sake of being concise, such as brake assemblies, electrical regeneration assemblies, sensors, bearings, seals, and so on.

This configuration provides numerous additional advantages, such as improving the ease of servicing the machine 100. For example, in this configuration the drive unit 105 may be easily removable from the machine 100 for servicing by unmounting the mounting flange 208 from the track frame 104, making access to the final drive 106, sprocket 108, and motor module 120 likewise easy. For example, after various connections (e.g., electrical connections, etc.) are detached from the drive unit 105, and the continuous track (which may be engaged with the sprocket 108 on the sprocket mounting flange 210) is lifted off, a servicing technician may just need to undo the fasteners attaching the mounting module 208 to the track frame 104 to remove the drive unit 105 from the machine 100 and service its various components.

FIG. 3 illustrates a cross-sectional view of a drive unit mounted to a track frame, in accordance with various embodiments. This example cross-sectional view illustrates a drive unit 105, such as the drive unit described above in FIG. 2, and a track frame 104 to which the drive unit 105 is mounted. The view is from the back of the track machine 100 looking forward. Accordingly, the example illustrates various parts of the track assembly 102, including the front idler 114, the top roller 118, and the continuous track 110. The main frame 101 of the machine, which is not illustrated, would be located to the right of the track assembly 102 and connected to the track assembly (e.g., via a pivot shaft and an equalizer bar), and a complementary track assembly would be located and connected on the other side of the main frame 101.

As illustrated in the example of FIG. 3, the final drive assembly 106 provides a mounting flange 208 that is mated and fastened to a complementary mounting surface 302 on the track frame 104 to mount the final drive 106, and in turn the drive unit 105, to the track frame 104. The motor module 120 is connected to the motor mounting flange 206 to mount the motor module 120 to the final drive assembly 106.

As illustrated, the final drive mounting flange 208 can be fixed to the motor mounting flange (e.g., the flanges 206, 208 can be the same component or they can be immovably connected together) so that mounting the final drive assembly 106 to the track frame 104 results in the motor module 120 also being fixed to the track frame 104.

The final drive mounting flange 208 further supports a spindle 304 in the final drive assembly 106 that rotatably supports rotating components of the final assembly 106, including the sprocket support flange 210. The sprocket 108 is fastened to the sprocket support flange 210.

The first electrical motor 202 and the second electrical motor 204 are in a stacked configuration in the motor module 120. The rotor shaft of the first motor 306 is rotatably connected to the rotor shaft of the second motor 308 so that the motors turn in unison.

The rotor shaft 308 extending out of the motor module 120 can make a rotational connection with an input shaft 312 in the final drive assembly 106 for driving the sprocket 108. The rotor shaft 308, through the input shaft 312, can engage various types of reduction gear sets 314 in the final drive assembly 106 for achieving desired reduction, such as planetary gears, as described above.

With the drive unit 105 mounted to the track frame 104, the motor module 120 can be operated to turn the rotatable portion of the final drive assembly 106 including the sprocket mounting flange 210 and mounted sprocket 108, thereby moving the tracks 110 and propelling the machine 100.

It should be noted that other components may be incorporated in the drive unit 105 that are not described here so as not to stray from the salient portions of the invention, such as brake assemblies, electrical regeneration assemblies, sensors, bearings, seals, and so on.

As illustrated, in this arrangement the rotational axis “X” of the motors 202, 204 in the motor module 120 coincides with the rotational axis of the final drive 106 and, accordingly, the sprocket 108. Namely, the motors 202, 204, final drive 106, and sprocket 108 are arranged coaxially. This arrangement has numerous advantages; for example, because the axes of the motor module 120 and final drive 106 coincide, the gear reduction mechanisms 314 transferring power from the motor module 120 to the final drive 106 can be simpler and more robust than in arrangements where the axes don't coincide. For example, the gear reduction mechanism 314 can utilize only planetary gear systems, which are known for their strength and reliability.

In various embodiments, the motor module 102 and motors 202, 204 are cantilevered out of the track frame 104 inboard, that is, in the direction towards the main frame 101 (not illustrated), while the final drive assembly 106 is cantilevered outboard, that is, in the direction away from the main frame 101.

In various embodiments, the motor module 102 and motors 202, 204 are mounted so that the axis of rotation of the motor module 102 and motors 202, 204 (which is aligned with the axis X in FIG. 3) is traverse

In some embodiments, the rotational axis of the motor module 102 can be parallel but not coincident with the rotational axis of the final drive assembly 106 and/or of the sprocket 108. For example, the motor module's 102 mounting position on the track frame 104 may be shifted laterally off-center from the final drive assembly 106 and/or the socket 108. This arrangement still has advantages over systems where the rotational axis of the motor is not parallel with the rotational axis of the final drive 106 and/or the socket 108 as the latter requires more complex and less reliable gear sets for transmitting motion along non-parallel rotational axes, such as bevel gears.

It should be understood that identical element symbols used on multiple figures refer to the same component, or components of equal functionality. Additionally, the accompanying figures are only meant to illustrate, not limit, the scope of the invention and should not be considered to be to scale.

Systems and methods have been described in general terms as an aid to understanding details of the invention. In some instances, well-known structures, materials, and/or operations have not been specifically shown or described in detail to avoid obscuring aspects of the invention. In other instances, specific details have been given in order to provide a thorough understanding of the invention. One skilled in the relevant art will recognize that the invention may be embodied in other specific forms, for example to adapt to a particular system or apparatus or situation or material or component, without departing from the spirit or essential characteristics thereof. Therefore, the disclosures and descriptions herein are intended to be illustrative, but not limiting, of the scope of the invention which is set forth in the following claims.

1. A tracked machine, comprising:
a main frame;
a track assembly comprising a continuous track supported on a track frame, the track frame being supported on the main frame;
a final drive assembly mounted to the track frame and an electrical motor mounted to the track frame such that the rotational axis of the electrical motor is parallel to the rotational axis of the final drive assembly, and wherein the electrical motor is configured to drive the final drive assembly and the final drive assembly is configured to drive the continuous track.

2. The tracked machine of claim 1, wherein the rotational axis of the electrical motor coincides with the rotational axis of the final drive assembly.

3. The tracked machine of claim 1, wherein the track frame is movably supported on the main frame in a manner providing for movement of the track frame relative to the main frame.

4. The tracked machine of claim 1, wherein the track frame is pivotally supported on the main frame in a manner providing for pivotal movement of the track frame relative to the main frame.

5. The tracked machine of claim 1, further comprising a sprocket mounted on the final drive assembly coaxially with the final drive assembly and the electrical motor, wherein the final drive assembly drives the sprocket and the sprocket engages the continuous track to move it.

6. The tracked machine of claim 1, further comprising:
a second track assembly comprising a second continuous track supported on a second track frame, the second track frame being supported on an opposite side of the main frame from the first track assembly;
a second final drive assembly mounted to the second track frame and a second electrical motor mounted to the second track frame such that the rotational axis of the second electrical motor is parallel to the rotational axis of the second final drive assembly, wherein the second electrical motor is configured to drive the second final drive assembly and the second final drive assembly is configured to drive the second continuous track.

7. The tracked machine of claim 1, wherein the electrical motor is an axial flux motor.

8. The tracked machine of claim 1, further comprising a second electrical motor stacked with the electrical motor, wherein either the rotor shafts of the motors are rotationally connected or the motors turn a shared rotor shaft.

9. The tracked machine of claim 1, wherein the electrical motor is mounted to the final drive assembly to form a drive unit, wherein the drive unit further comprises a mounting flange for attaching the drive unit to the track frame.

10. A track assembly, comprising:
a continuous track supported on a track frame;
a final drive assembly mounted to the track frame and an electrical motor mounted to the track frame such that the rotational axis of the electrical motor is parallel to the rotational axis of the final drive assembly, wherein the electrical motor is configured to drive the final drive assembly and the final drive assembly is configured to drive the continuous track.

11. The track assembly of claim 8, wherein the rotational axis of the electrical motor coincides with the rotational axis of the final drive assembly.

12. The track assembly of claim 8, further comprising a sprocket mounted on the final drive assembly coaxially with the final drive assembly and the electrical motor, wherein the final drive assembly drives the sprocket and the sprocket engages the continuous track to move it.

13. The track assembly of claim 8, wherein the electrical motor is an axial flux motor.

14. The track assembly of claim 8, further comprising a second electrical motor stacked with the electrical motor, wherein either the rotor shafts of the motors are rotationally connected or the motors turn a shared rotor shaft.

15. The track assembly of claim 8, wherein the electrical motor is mounted to the final drive assembly to form a drive unit, wherein the drive unit further comprises a mounting flange for attaching the drive unit to the track frame.

16. A drive unit, comprising:
an electrical motor mounted to a final drive assembly such that the rotational axis of the electrical motor is parallel to the rotational axis of the final drive assembly; and
a mounting flange for attaching the drive unit to a track frame of a tracked machine, the drive unit being configured to drive a continuous track supported on the track frame.

17. The drive unit of claim 16, wherein the rotational axis of the electrical motor coincides with the rotational axis of the final drive assembly.

18. The drive unit of claim 16, wherein the electrical motor is an axial flux motor.

19. The drive unit of claim 16, further comprising a second electrical motor stacked with the electrical motor, wherein either the rotor shafts of the motors are rotationally connected or the motors turn a shared rotor shaft.

20. The drive unit of claim 18, wherein the final drive assembly uses a planetary gear system.
